(19) United States
(12) Patent Application Publication
(10) Pub. No.: US 2011/0001792 A1
(43) Pub. Date: Jan. 6, 2011

(54) VIRTUAL REFERENCE VIEW

(76) Inventors: Purvin Bibhas Pandit, Franklin Park, NJ (US); Peng Yin, Plainsboro, NJ (US); Dong Tian, Plainsboro, NJ (US)

Correspondence Address: Robert D. Shedd, Patent Operations;THOMSON Licensing LLC, P.O. Box 5312, Princeton, NJ, 08543-5312, US

(21) Appl. No.: 12/736,043

(22) PCT Filed: Mar. 3, 2009
(86) PCT No.: PCT/US2009/001347

§ 371 Date: Sep. 3, 2010

Related U.S. Application Data
(60) Provisional application No. 61/068,070, filed on Mar. 4, 2008.

(51) Int. Cl. H04N 13/00

(52) U.S. Cl. 348/43; 348/E13.06

(57) ABSTRACT

Various implementations are described. Several implementations relate to a virtual reference view. According to one aspect, coded information is accessed for a first-view image. A reference image is accessed that depicts the first-view image from a virtual-view location different from the first-view. The reference image is based on a synthesized image for a location that is between the first-view and the second-view. Coded information is accessed for a second-view image coded based on the reference image. The second-view image is decoded. According to another aspect, a first-view image is accessed. A virtual image is synthesized based on the first-view image, for a virtual-view location different from the first-view. A second-view image is encoded using a reference image based on the virtual image. The second-view is different from the virtual-view location. The encoding produces an encoded second-view image.

### CROSS-REFERENCE TO RELATED APPLICATIONS

This application claims the benefit of U.S. Provisional Application Ser. No. 61/068,070, filed on Mar. 4, 2008, titled “Virtual Reference View”, the contents of which are hereby incorporated by reference in their entirety for all purposes.

### TECHNICAL FIELD

Implementations are described that relate to coding systems. Various particular implementations relate to a virtual reference view.

### BACKGROUND

It has been widely recognized that Multi-view Video Coding is a key technology that serves a wide variety of applications, including free-viewpoint and three-dimensional (3D ) video applications, home entertainment and surveillance. In addition, depth data may be associated with each view. Depth data is generally essential for view synthesis. In those multi-view applications, the amount of video and depth data involved is typically enormous. Thus, there exists at least the desire for a framework that helps improve the coding efficiency of current video coding solutions performing simulcast of independent views.

A multi-view video source includes multiple views of the same scene. As a result, there typically exists a high degree of correlation between the multiple view images. Therefore, view redundancy can be exploited in addition to temporal redundancy. View redundancy can be exploited by, for example, performing view prediction across the different views.

In a practical scenario, multi-view video systems will capture the scene using sparsely placed cameras. The views in between these cameras can then be generated using available depth data and captured views by view synthesizes/interpolation. Additionally some views may only carry depth information and are then subsequently synthesized at the decoder using the associated depth data. Depth data can also be used to generate intermediate virtual views. In such a sparse system, the correlation between the captured views may not be large and the prediction across views may be very limited.

### SUMMARY

According to a general aspect, coded video information is accessed for a first-view image that corresponds to a first-view location. A reference image is accessed that depicts the first-view image from a virtual-view location different from the first-view location. The reference image is based on a synthesized image for a location that is between the first-view location and the second-view location. Coded video information is accessed for a second-view image that corresponds to a second-view location, wherein the second-view image has been coded based on the reference image. The second-view image is decoded using the coded video information for the second-view image and the reference image to produce a decoded second-view image.

According to another general aspect, a first-view image is accessed that corresponds to a first-view location. A virtual image is synthesized based on the first-view image, for a virtual-view location different from the first-view location. A second-view image is encoded corresponding to a second-view location. The encoding uses a reference image that is based on the virtual image. The second-view location is different from the virtual-view location. The encoding produces an encoded second-view image.

The details of one or more implementations are set forth in the accompanying drawings and the description below. Even if described in one particular manner, it should be clear that implementations may be configured or embodied in various manners. For example, an implementation may be performed as a method, or embodied as apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 is a diagram of an implementation of a system for transmitting and receiving multi-view video with depth information.

FIG. 2 is a diagram of an implementation of a framework for generating nine output views (N=9) out of 3 input views with depth (K=3).

FIG. 3 is a diagram of an implementation of an encoder.

FIG. 4 is a diagram of an implementation of a decoder.

FIG. 5 is a block diagram of an implementation of a video transmitter.

FIG. 6 is a block diagram of an implementation of a video receiver.

FIG. 7A is a diagram of an implementation of an encoding process.

FIG. 7B is a diagram of an implementation of a decoding process.

FIG. 8A is a diagram of an implementation of an encoding process.

FIG. 8B is a diagram of an implementation of a decoding process.

FIG. 9 is an example of a depth map.

FIG. 10A is an example of a warped picture without hole filling.

FIG. 10B is an example the warped picture of FIG. 10A with hole filling.

FIG. 11 is a diagram of an implementation of an encoding process.

FIG. 12 is a diagram of an implementation of a decoding process.

FIG. 13 is a diagram of an implementation of successive virtual view generator.

FIG. 14 is a diagram of an implementation of an encoding process.

FIG. 15 is a diagram of an implementation of a decoding process.

### DETAILED DESCRIPTION

In at least one implementation, we propose a framework to use a virtual view as a reference. In at least one implementation, we propose to use a virtual view which is not collocated with the view that is to be predicted as an additional reference. In another implementation, we also propose to successively refine the virtual reference view until a certain quality versus complexity trade off is met. We may then include several virtually generated views as additional references and indicate at a high level their locations in the reference list.

Thus, at least one problem addressed by at least some implementations is the efficient coding of multi-view video sequences using virtual views as additional references. A multi-view video sequence is a set of two or more video sequences that capture the same scene from different view points.

Free-viewpoint television (FTV) is a new framework that includes a coded representation for multi-view video and depth information and targets the generation of high-quality intermediate views at the receiver. This enables free viewpoint functionality and view generation for auto-stereoscopic displays.

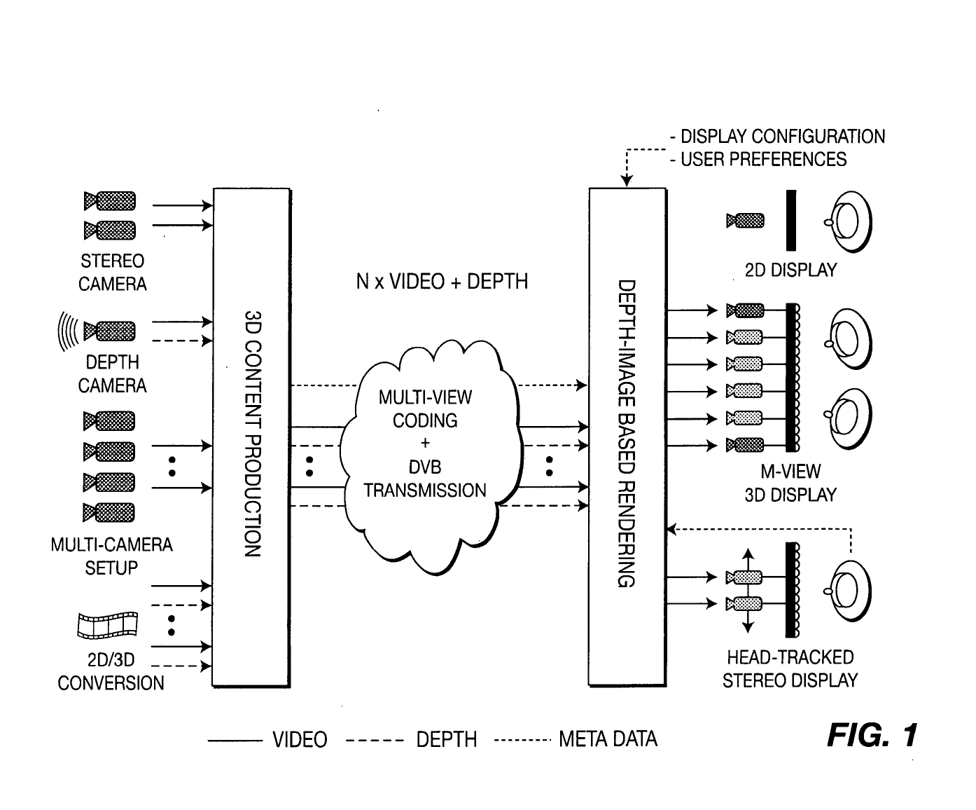

FIG. 1 shows an exemplary system 100 for transmitting and receiving multi-view video with depth information, to which the present principles may be applied, according to an embodiment of the present principles. In FIG. 1, video data is indicated by a solid line, depth data is indicated by a dashed line, and meta data is indicated by a dotted line. The system 100 may be, for example, but is not limited to, a free-viewpoint television system. At a transmitter side 110, the system 100 includes a three-dimensional (3D) content producer 120, having a plurality of inputs for receiving one or more of video, depth, and meta data from a respective plurality of sources. Such sources may include, but are not limited to, a stereo camera 111, a depth camera 112, a multi-camera setup 113, and 2-dimensional/3-dimensional (2D/3D) conversion processes 114. One or more networks 130 may be used for transmit one or more of video, depth, and meta data relating to multi-view video coding (MVC) and digital video broadcasting (DVB).

At a receiver side 140, a depth image-based renderer 150 performs depth image-based rendering to project the signal to various types of displays. The depth image-based renderer 150 is capable of receiving display configuration information and user preferences. An output of the depth image-based renderer 150 may be provided to one or more of a 2D display 161, an M-view 3D display 162, and/or a head-tracked stereo display 163.

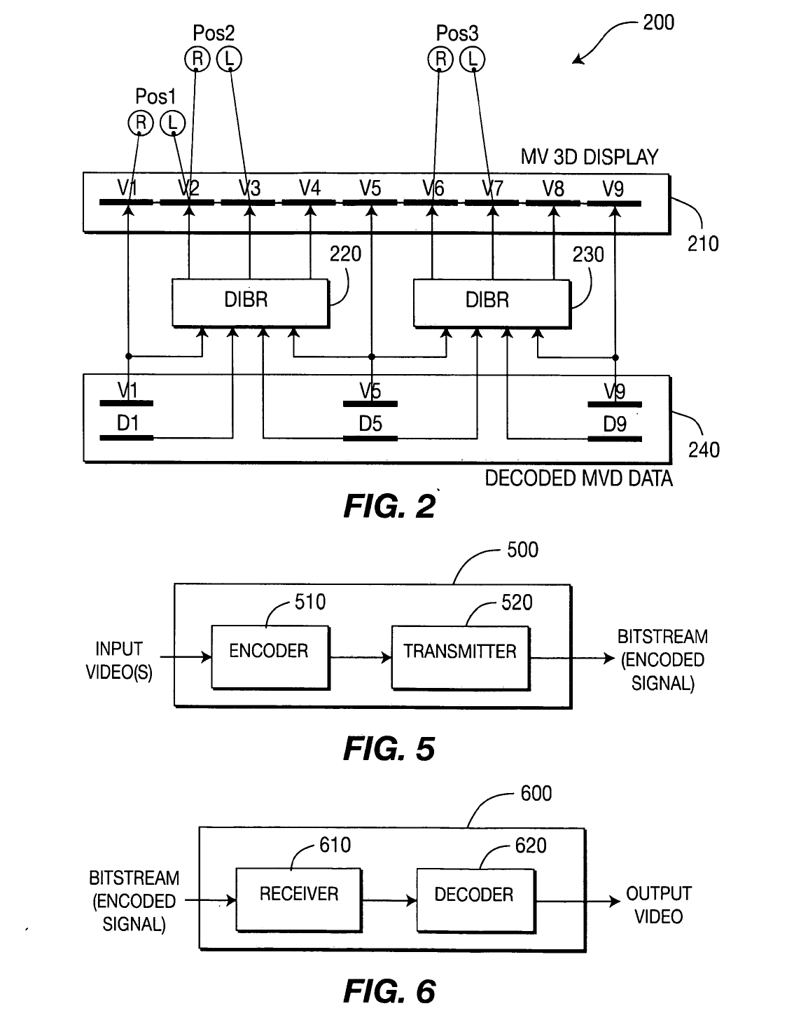

In order to reduce the amount of data to be transmitted, the dense array of cameras (V1, V2 . . . V9) may be sub-sampled and only a sparse set of cameras actually capture the scene. FIG. 2 shows an exemplary framework 200 for generating nine output views (N=9) out of 3 input views with depth (K=3), to which the present principles may be applied, in accordance with an embodiment of the present principles. The framework 200 involves an auto-stereoscopic 3D display 210, which supports output of multiple views, a first depth image-based renderer 220, a second depth image-based renderer 230, and a buffer for decoded data 240. The decoded data is a representation known as Multiple View plus Depth (MVD) data. The nine cameras are denoted by V1 through V9. Corresponding depth maps for the three input views are denoted by D1, D5, and D9. Any virtual camera positions in between the captured camera positions (e.g., Pos 1, Pos 2, Pos 3) can be generated using the available depth maps (D1, D5, D9), as shown in FIG. 2. As can be seen in FIG. 2, the baseline between the actual cameras (V1, V5 and V9) used to capture data can be large. As a result, the correlation between these cameras is significantly reduced and coding efficiency of these cameras may suffer since the coding efficiency would only rely on temporal correlation.

In at least one described implementation, we propose to address this problem of improving the coding efficiency of cameras with a large baseline. The solution is not limited to multi-view view coding, but can also be applied to multi-view depth coding.

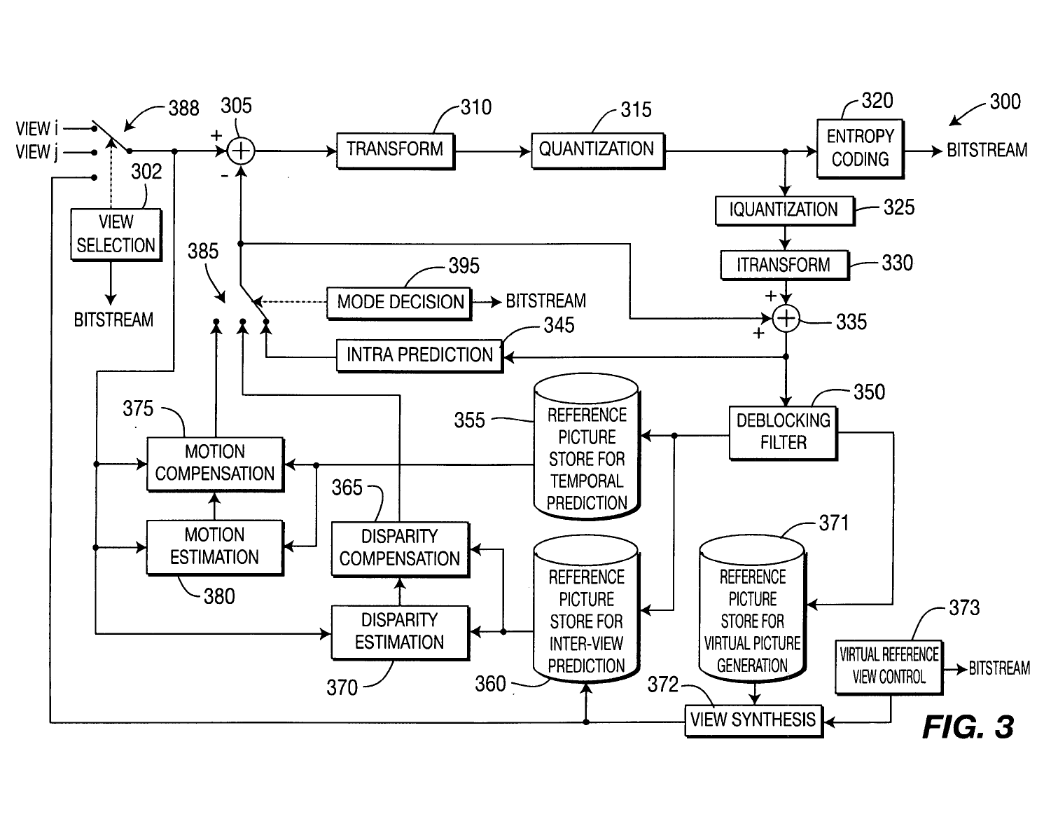

FIG. 3 shows an exemplary encoder 300 to which the present principles may be applied, in accordance with an embodiment of the present principles. The encoder 300 includes a combiner 305 having an output connected in signal communication with an input of a transformer 310. An output of the transformer 310 is connected in signal communication with an input of quantizer 315. An output of the quantizer 315 is connected in signal communication with an input of an entropy coder 320 and an input of an inverse quantizer 325. An output of the inverse quantizer 325 is connected in signal communication with an input of an inverse transformer 330. An output of the inverse transformer 330 is connected in signal communication with a first non-inverting input of a combiner 335. An output of the combiner 335 is connected in signal communication with an input of an intra predictor 345 and an input of a deblocking filter 350. The deblocking filter 350 removes, for example, artifacts along macroblock boundaries. A first output of the deblocking filter 350 is connected in signal communication with an input of a reference picture store 355 (for temporal prediction) and a first input of a reference picture store 360 (for inter-view prediction). An output of the reference picture store 355 is connected in signal communication with a first input of a motion compensator 375 and a first input of a motion estimator 380. An output of the motion estimator 380 is connected in signal communication with a second input of the motion compensator 375. An output of the reference picture store 360 is connected in signal communication with a first input of a disparity estimator 370 and a first input of a disparity compensator 365. An output of the disparity estimator 370 is connected in signal communication with a second input of the disparity compensator 365.

A second output of the deblocking filter 350 is connected in signal communication with an input of a reference picture store 371 (for virtual picture generation). An output of the reference picture store 371 is connected in signal communication with a first input of a view synthesizer 372. A first output of a virtual reference view controller 373 is connected in signal communication with a second input of the view synthesizer 372.

An output of the entropy decoder 320, a second output of the virtual reference view controller 373, a first output of a mode decision module 395, and an output of a view selector 302, are each available as respective outputs of the encoder 300, for outputting a bitstream. A first input (for picture data for view i), a second input (for picture data for view j), and a third input (for picture data for a synthesized view) of a switch 388 are each available as respective inputs to the encoders. An output (for providing a synthesized view) of the view synthesizer 372 is connected in signal communication with a second input of the reference picture store 360 and the third input of the switch 388. A second output of the view selector 302 determines which input (e.g., picture data for view i, view j, or a synthesized view) is provided to the switch 388. An output of the switch 388 is connected in signal communication with a non-inverting input of the combiner 305, a third input of the motion compensator 375, a second input of the motion estimator 380, and a second input of the disparity estimator 370. An output of an intra predictor 345 is connected in signal communication with a first input of a switch 385. An output of the disparity compensator 365 is connected in signal communication with a second input of the switch 385. An output of the motion compensator 375 is connected in signal communication with a third input of the switch 385. An output of the mode decision module 395 determines which input is provided to the switch 385. An output of a switch 385 is connected in signal communication with a second non-inverting input of the combiner 335 and with an inverting input of the combiner 305.

Portions of FIG. 3 may also be referred to as an encoder, an encoding unit, or an accessing unit, such as, for example, blocks 310, 315, and 320, either individually or collectively. Similarly, blocks 325, 330, 335, and 350, for example, may be referred to as a decoder or decoding unit, either individually or collectively.

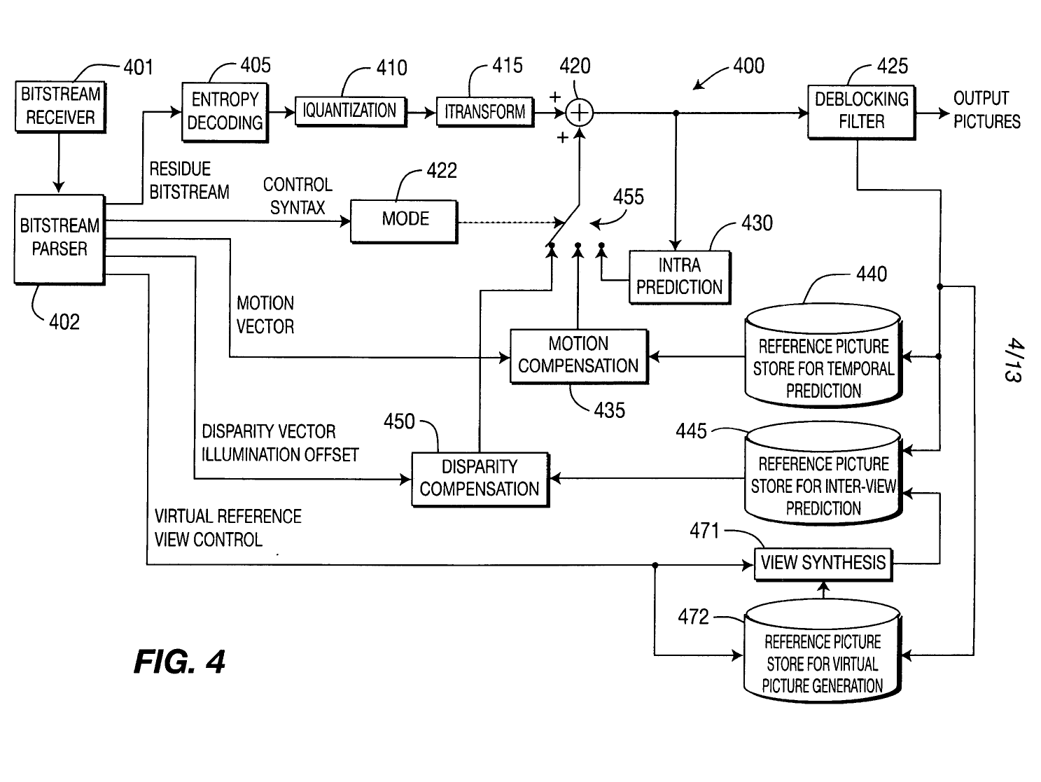

FIG. 4 shows an exemplary decoder 400 to which the present principles may be applied, in accordance with an embodiment of the present principles. The decoder 400 includes an entropy decoder 405 having an output connected in signal communication with an input of an inverse quantizer 410. An output of the inverse quantizer is connected in signal communication with an input of an inverse transformer 415. An output of the inverse transformer 415 is connected in signal communication with a first non-inverting input of a combiner 420. An output of the combiner 420 is connected in signal communication with an input of a deblocking filter 425 and an input of an intra predictor 430. An output of the deblocking filter 425 is connected in signal communication with an input of a reference picture store 440 (for temporal prediction), a first input of a reference picture store 445 (for inter-view prediction), and a first input of a reference picture store 472 (for virtual picture generation). An output of the reference picture store 440 is connected in signal communication with a first input of a motion compensator 435. An output of a reference picture store 445 is connected in signal communication with a first input of a disparity compensator 450.

An output of a bitstream receiver 401 is connected in signal communication with an input of a bitstream parser 402. A first output (for providing a residue bitstream) of the bitstream parser 402 is connected in signal communication with an input of the entropy decoder 405. A second output (for providing control syntax to control which input is selected by the switch 455) of the bitstream parser 402 is connected in signal communication with an input of a mode selector 422. A third output (for providing a motion vector) of the bitstream parser 402 is connected in signal communication with a second input of the motion compensator 435. A fourth output (for providing a disparity vector and/or illumination offset) of the bitstream parser 402 is connected in signal communication with a second input of the disparity compensator 450. A fifth output (for providing virtual reference view control information) of the bitstream parser 402 is connected in signal communication with a second input of the reference picture store 472 and a first input of the view synthesizer 471. An output of the reference picture store 472 is connected in signal communication with a second input of the view synthesizer. An output of the view synthesizer 471 is connected in signal communication with a second input of the reference picture store 445. It is to be appreciated that illumination offset is an optional input and may or may not be used, depending upon the implementation.

An output of a switch 455 is connected in signal communication with a second non-inverting input of the combiner 420. A first input of the switch 455 is connected in signal communication with an output of the disparity compensator 450. A second input of the switch 455 is connected in signal communication with an output of the motion compensator 435. A third input of the switch 455 is connected in signal communication with an output of the intra predictor 430. An output of the mode module 422 is connected in signal communication with the switch 455 for controlling which input is selected by the switch 455. An output of the deblocking filter 425 is available as an output of the decoder.

Portions of FIG. 4 may also be referred to as an accessing unit, such as, for example, bitstream parser 402 and any other block that provides access to a particular piece of data or information, either individually or collectively. Similarly, blocks 405, 410, 415, 420, and 425, for example, may be referred to as a decoder or decoding unit, either individually or collectively.

FIG. 5 shows a video transmission system 500, to which the present principles may be applied, in accordance with an implementation of the present principles. The video transmission system 500 may be, for example, a head-end or transmission system for transmitting a signal using any of a variety of media, such as, for example, satellite, cable, telephone-line, or terrestrial broadcast. The transmission may be provided over the Internet or some other network.

The video transmission system 500 is capable of generating and delivering video content including virtual reference views. This is achieved by generating an encoded signal(s) including one or more virtual reference views or information capable of being used to synthesize the one or more virtual reference views at a receiver end that may, for example, have a decoder.

The video transmission system 500 includes an encoder 510 and a transmitter 520 capable of transmitting the encoded signal. The encoder 510 receives video information, synthesizes one or more virtual reference views based on the video information, and generates an encoded signal(s) therefrom. The encoder 510 may be, for example, the encoder 300 described in detail above.

The transmitter 520 may be, for example, adapted to transmit a program signal having one or more bitstreams representing encoded pictures and/or information related thereto. Typical transmitters perform functions such as, for example, one or more of providing error-correction coding, interleaving the data in the signal, randomizing the energy in the signal, and modulating the signal onto one or more carriers. The transmitter may include, or interface with, an antenna (not shown). Accordingly, implementations of the transmitter 520 may include, or be limited to, a modulator.

FIG. 6 shows a diagram of an implementation of a video receiving system 600. The video receiving system 600 may be configured to receive signals over a variety of media, such as, for example, satellite, cable, telephone-line, or terrestrial broadcast. The signals may be received over the Internet or some other network.

The video receiving system 600 may be, for example, a cell-phone, a computer, a set-top box, a television, or other device that receives encoded video and provides, for example, decoded video for display to a user or for storage. Thus, the video receiving system 600 may provide its output to, for example, a screen of a television, a computer monitor, a computer (for storage, processing, or display), or some other storage, processing, or display device.

The video receiving system 600 is capable of receiving and processing video content including video information. Moreover, the video receiving system 600 is capable of synthesizing and/or otherwise reproducing one or more virtual reference views. This is achieved by receiving an encoded signal(s) including video information and the one or more virtual reference views or information capable of being used to synthesize the one or more virtual reference views.

The video receiving system 600 includes a receiver 610 capable of receiving an encoded signal, such as for example the signals described in the implementations of this application, and a decoder 620 capable of decoding the received signal.

The receiver 610 may be, for example, adapted to receive a program signal having a plurality of bitstreams representing encoded pictures. Typical receivers perform functions such as, for example, one or more of receiving a modulated and encoded data signal, demodulating the data signal from one or more carriers, de-randomizing the energy in the signal, de-interleaving the data in the signal, and error-correction decoding the signal. The receiver 610 may include, or interface with, an antenna (not shown). Implementations of the receiver 610 may include, or be limited to, a demodulator.

The decoder 620 outputs video signals including video information and depth information. The decoder 620 may be, for example, the decoder 400 described in detail above.

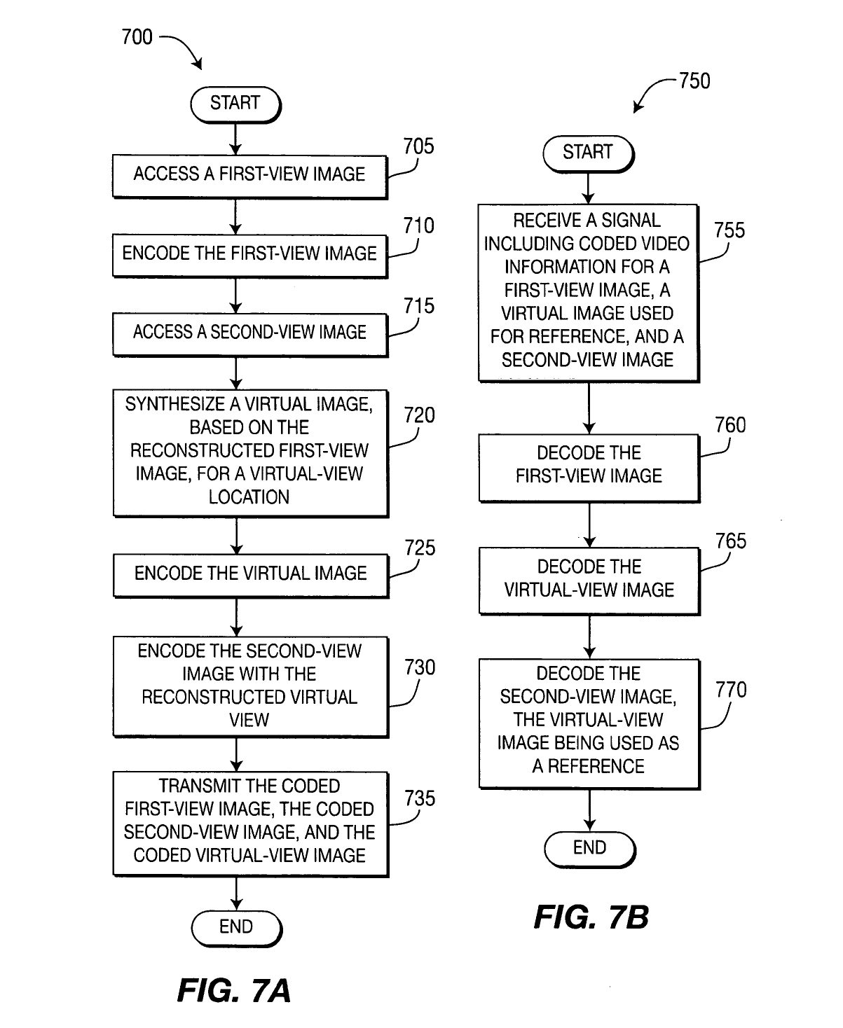

FIG. 7A shows a flowchart of a method 700 for encoding a virtual reference view, in accordance with an embodiment of the present principles. At step 710, a first-view image taken from a device at a first-view location is accessed. At step 710, the first view image is encoded. At step 715, a second-view image taken from a device at a second-view location. At step 720, a virtual image is synthesized based on the reconstructed first-view image. The virtual image estimates what an image would look like if taken from a device at a virtual-view location different from the first-view location. At step 725, the virtual image is encoded. At step 730, the second-view image is encoded with the reconstructed virtual view as an additional reference to the reconstructed first-view image. The second-view location is different from the virtual-view location. At step 735, the coded first-view image, the coded virtual-view image, and the coded second-view image are transmitted.

In one implementation of the method 700, the first view image from which the virtual image is synthesized is a reconstructed version of the first view image, and the reference image is the virtual image.

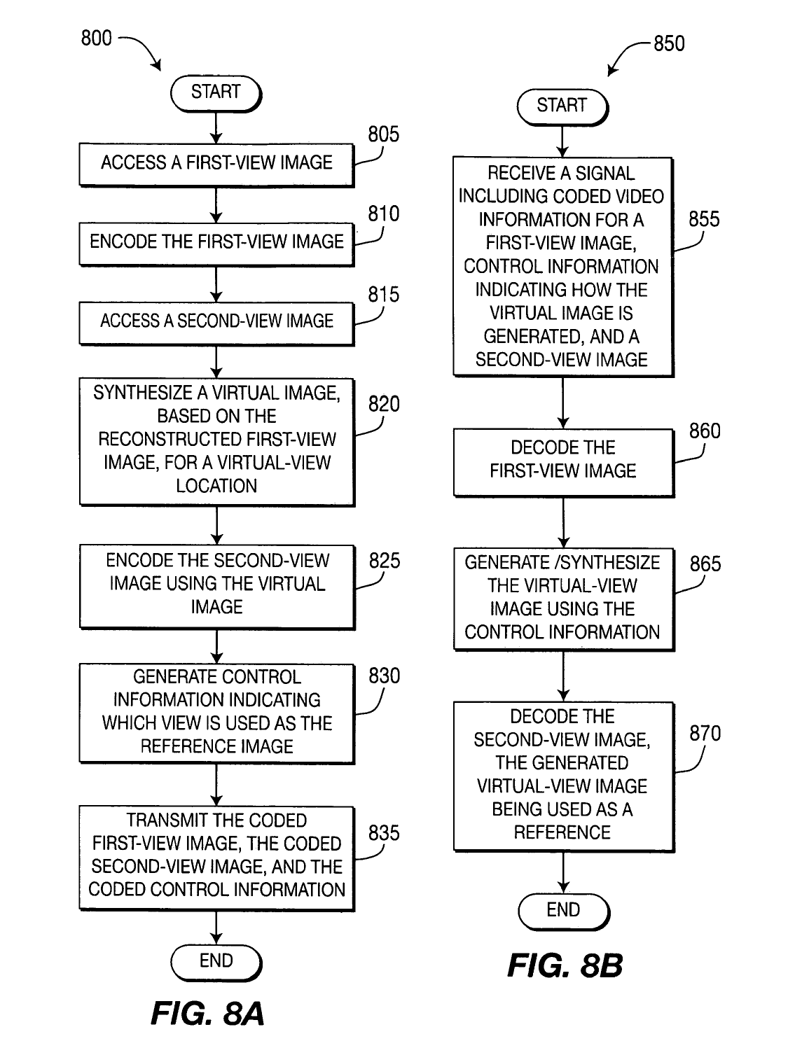

In other implementations of the general process of FIG. 7A, as well as other processes described in this application (including, for example, the processes of FIGS. 7B, 8A, and 8B), the virtual image (or a reconstruction) may be the only reference image used in encoding the second-view image. Additionally, implementations may allow the virtual image to be displayed at a decoder as output.

Many implementations encode and transmit the virtual-view image. In such implementations, this transmission and the bits used in the transmission may be taken into account in a validation performed by a hypothetical reference decoder (HRD) (for example, an HRD that is included in an encoder or an independent HRD checker). In a current multi-view coding (MVC) standard, the HRD verification is performed for each view separately. If a second-view is predicted from a first view, the rate used in transmitting the first-view is counted in the HRD checking (validation) of the coded picture buffer (CPB) for the second-view. This accounts for the fact that the first-view is buffered in order to decode the second-view. Various implementations use the same philosophy as that just described for MVC. In such implementations, if the virtual-view reference image that is transmitted is in between the first-view and the second-view, then the HRD model parameters for the virtual-view are inserted into the sequence parameter set (SPS) just as if it were a real view. Additionally, when checking the HRD conformance (validation) of the CPB for the second-view, the rate used for the virtual-view is counted in the formula to account for buffering of the virtual-view.

FIG. 7B shows a flowchart of a method 750 for decoding a virtual reference view, in accordance with an embodiment of the present principles. At step 755, a signal is received that includes coded video information for a first-view image taken from a device at a first-view location, a virtual image used for reference only (no output such as displaying the virtual image), and a second-view image taken from a device at a second-view location. At step 760, the first-view image is decoded. At step 765, the virtual-view image is decoded. At step 770, the second-view image and the decoded virtual-view image being used as an additional reference for the decoded first-view image are decoded.

FIG. 8A shows a flowchart of a method 800 for encoding a virtual reference view, in accordance with an embodiment of the present principles. At step 805, a first view image taken from a device at a first-view location is accessed. At step 810, the first-view image is encoded. At step 815, a second-view image taken from a device at a first-view location is accessed. At step 820, a virtual image is synthesized, based on the reconstructed first-view image. The virtual image estimates what an image would look like if taken from a device at a virtual-view location different from the first-view location. At step 825, the second-view image is encoded, using the virtual image generated as an additional reference to the reconstructed first-view image. The second view location is different from the virtual-view location. At step 830, control information is generated for indicating which view of a plurality of views is used as the reference image. In such a case, the reference image may, for example, be one of:

(1) a synthesized view half way between the first-view location and the second-view location;

(2) a synthesized view for a same location as a current view being encoded, the synthesized view having been incrementally synthesized starting by generating a synthesis of a view at the half-way point and then using a result thereof to synthesize another view at a location of the current view being encoded;

(3) a non-synthesized-view image;

(4) the virtual image; and

(5) another separate synthesized image that is synthesized from the virtual image, and the reference image is at a location between the first-view image and the second-view image or at a location of the second view image

At step 835, the coded first-view image, the coded second-view image, and the coded control information are transmitted.

The process of FIG. 8A, as well as various other processes described in this application, may also include a decoding step at the encoder. For example, the encoder may decode the encoded second-view image using the synthesized virtual image. This is expected to produce a reconstructed second-view image that matches what the decoder will generate. The encoder can then use the reconstruction to encode subsequent images, using the reconstruction as a reference image. In this way, the encoder uses the reconstruction of the second-view image to encode a subsequent image, and the decoder will also use the reconstruction to decode the subsequent image. As a result, the encoder can base its rate-distortion optimization and its choice of encoding mode, for example, on the same final output (a reconstruction of the subsequent image) that the decoder is expected to produce. This decoding step could be performed, for example, at any point after operation 825.

FIG. 8B shows a flowchart of a method 800 for decoding a virtual reference view, in accordance with an embodiment of the present principles. At step 855, a signal is received. The signal includes coded video information for a first-view image taken from a device at a first-view location, a second-view image taken from a device at a second-view location, and control information for how the virtual image is generated which is used for reference only (no output). At step 860, the first-view image is decoded. At step 865, the virtual-view image is generated/synthesized using the control information. At step 870, the second-view image is decoded, using the generated/synthesized virtual-view image as an additional reference to the decoded first-view image.

### Embodiment 1

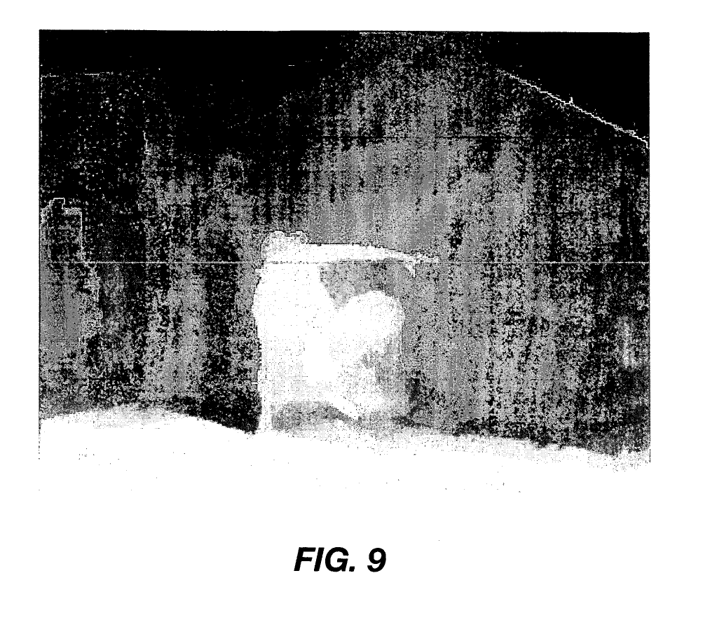

Virtual views can be generated from existing views using the 3D warping technique. In order to obtain the virtual view, information about the cameras intrinsic and extrinsic parameters are used. Intrinsic parameters may include, for example, but are not limited to, focal length, zoom, and other internal characteristics. Extrinsic parameters may include, for example, but are not limited to, position (translation), orientation (pan, tilt, rotation), and other external characteristics. In addition, the depth map of the scene is also used. FIG. 9 shows an exemplary depth map 900, to which the present principles may be applied, in accordance with an embodiment of the present principles. In particular, the depth map 900 is for view 0.

The perspective projection matrix for 3D warping can be represented as follows:

PM=A[R|t] (1)

where A, R, and t denote the intrinsic matrix, rotation matrix, and translation vector, respectively, and these values are referred to as camera parameters. We can project pixel positions from the image coordinate to the 3D world coordinate using the projection equation. Equation (2) is the projection equation, which includes the depth data and Equation (1). Equation (2) can be transformed to Equation. (3).

P_{ref}(x,y,1)·D=A[R|t]·\tilde{P}_{WC}(x,y,z,1) (2)

P_{WC}(x,y,z)=R⁻¹·A⁻¹·P_{ref}(x,y,1)·D −R⁻¹·t (3)

where D denotes the depth data, P denotes the pixel position on the 3D world coordinate or the homogenous coordinate in the reference image coordinate system, and \tilde{P} denotes the homogenous coordinate in the 3D world coordinate system. After the projection, the pixel positions in the 3D world coordinate are mapped into the positions in the desired target image by Equation (4) that is the inverse form of Equation (1).

P_{target}(x,y,1)=A·R·(P_{WC}(x,y,z)+R⁻¹·t) (4)

Then, we can get the right pixel positions in the target image with respect to the pixel positions in the reference image. After that, we copy the pixel values from the pixel positions on the reference image to the projected pixel positions on the target image.

In order to synthesize virtual views, we use camera parameters of references views and virtual views. However, a full set of camera parameters for virtual views is not necessarily signaled. If the virtual view is only a shift in the horizontal plane (see, e.g., the example of FIG. 2 from view 1 to view 2), then only the translation vector needs to be updated and the remaining parameters stay the same.

In an apparatus such as apparatus 300 and apparatus 400 shown and described with respect to FIGS. 3 and 4, one coding structure would be such that view 5 uses view 1 as a reference in the prediction loop. However, as mentioned above, due to the large baseline distance between them, the correlation would be limited, and the probability of view 5 using view 1 as reference would be very low.

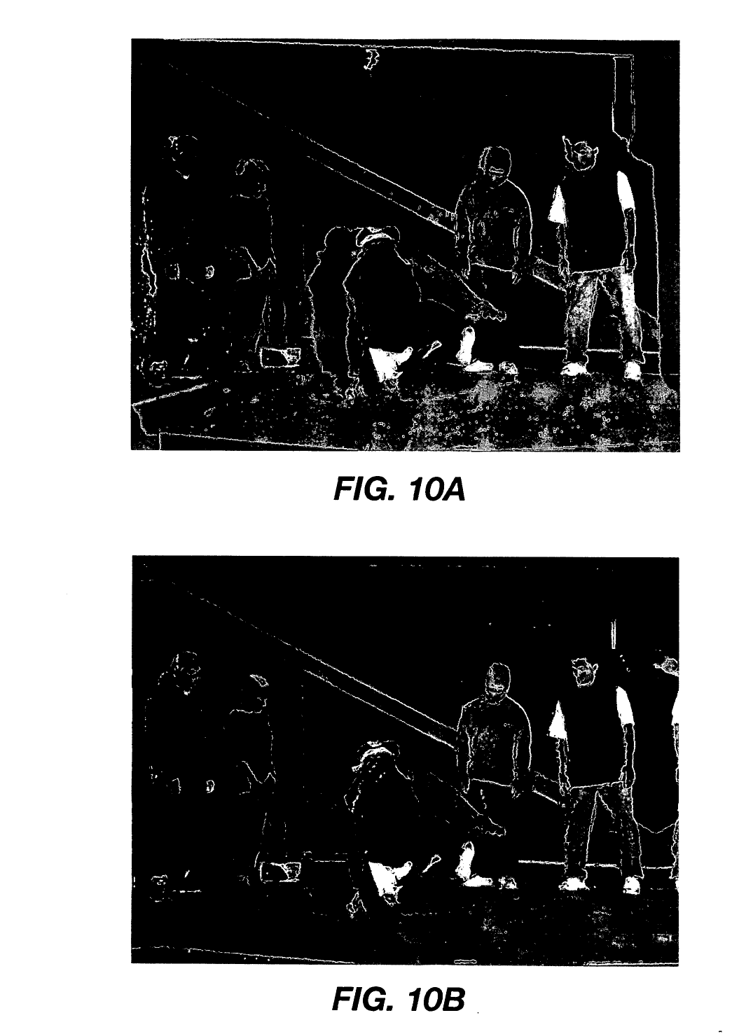

We can warp view 1 to the camera position of view 5 and then use this virtually generated picture as an additional reference. However, due to the large baseline, the virtual view will have many holes or larger holes which might not be trivial to fill. Even after hole filling, the final image may not have acceptable quality to be used as reference. FIG. 10A shows an exemplary warped picture without hole filling 1000. FIG. 10B shows the exemplary warped picture of FIG. 10A with hole filling 1050. As can be seen from FIG. 10A, there are several holes to the left of the break dancer and on the right side of the frame. These holes are then filled using a hole filling algorithm like inpainting and the result can be seen in FIG. 10B.

In order to address the large baseline problem we propose that instead of directly warping view 1 to camera position view 5, we instead warp to a location that is somewhere in between view 1 and view 5, for example, mid-point between the 2 cameras. This position is closer to view 1 compared to view 5 and will potentially have fewer and smaller holes. These smaller/fewer holes are easier to manage compared to the larger holes with a large baseline. In reality, any position between the 2 cameras can be generated instead of directly generating a position corresponding to view 5. In fact, multiple virtual camera positions can be generated as additional references.

In case of linear and parallel camera arrangements, we typically only need to signal the translational vector corresponding to the virtual position that is generated since all other information should be already available. In order to support generation of one or more additional warped references, we propose to add syntax in, for example, the slice header. An embodiment of the proposed slice header syntax is shown in Table 1. An embodiment of the proposed virtual view information syntax is shown in Table 2. As noted by the logic in Table 1 (shown in italics), the syntax presented in Table 2 is only present when the conditions specified in Table 1 are satisfied. These conditions being: the current slice is EP or EB slice; and the profile is the multi-view video profile. Note that Table 2 includes “I0” information for P, EP, B, and EB slices, and further includes “I1” information for B and EB slices. By using the appropriate reference list ordering syntax, we can create multiple warped references. For example, the first reference picture could be the original reference, the second reference picture one could be a warped reference at a point between the reference and the current view and the third reference picture could be a warped reference at the current view position.

TABLE 1

| slice_header( ) { | C | Descriptor |
|---|---|---|
| first_mb_in_slice | 2 | ue(v) |
| slice_type | 2 | ue(v) |
| pic_parameter_set_id | 2 | ue(v) |
| ...... | | |
| ref_pic_list_reordering( ) | 2 | |
| if( ( weighted_pred_flag && ( slice_type = = P \| \| | | |
| slice_type = = SP ) ) \| \| | | |
| ( weighted_bipred_idc = = 1 && | | |
| slice_type = = B ) ) | | |
| pred_weight_table( ) | 2 | |
| if( (slice_type = = EP \|\| slice_type = = EB) | | |
| && profile_idc = = MULTIVIEW_PROFILE) | | |
| virtual_view_info( ) | | |
| ...... | | |
| if( num_slice_groups_minus1 > 0 && | | |
| slice_group_map_type >= 3 && | | |
| slice_group_map_type <= 5) | | |
| slice_group_change_cycle | 2 | u(v) |
| } | | |

TABLE 2

| virtual_view_info ( ) { | C | Descriptor |
|---|---|---|
| for( i = 0; i <= num_ref_idx_l0_active_minus1; | | |
| i++ ) { | | |
| virtual_view_l0_flag | 2 | u(1) |
| if( virtual_view_l0_flag ) { | | |
| translation_offset_x_l0 | 2 | se(v) |
| translation_offset_y_l0 | 2 | se(v) |
| translation_offset_z_l0 | 2 | se(v) |
| pan_l0 | 2 | se(v) |
| tilt_l0 | 2 | se(v) |
| rotate_l0 | 2 | se(v) |
| zoom_l0 | 2 | se(v) |
| hole_filling_mode_l0 | 2 | se(v) |
| depth_filter_type_l0 | 2 | se(v) |
| video_filter_type_l0 | 2 | se(v) |
| } | | |
| } | | |
| if( slice_type % 5 = = 1 ) | | |
| for( i = 0; i <= num_ref_idx_l1_active_minus1; | | |
| i++ ) { | | |
| virtual_view_l1_flag | 2 | u(1) |
| if( virtual_view_l1_flag ) { | | |
| translation_offset_x_l1 | 2 | se(v) |
| translation_offset_y_l1 | 2 | se(v) |
| translation_offset_z_l1 | 2 | se(v) |
| pan_l1 | 2 | se(v) |
| tilt_l1 | 2 | se(v) |
| rotate_l1 | 2 | se(v) |
| zoom_l1 | 2 | se(v) |
| hole_filling_mode_l1 | 2 | se(v) |
| depth_filter_type_l1 | 2 | se(v) |
| video_filter_type_l1 | 2 | se(v) |
| } | | |
| } | | |
| } | | |

Note the syntax elements indicated in bold font in Tables 1 and 2 that would typically appear in a bitstream. Further, since Table 1 is a modification of the existing International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “MPEG-4 AVC Standard”) slice header syntax, for convenience, some portions of the existing syntax that are unchanged are shown with ellipsis.

The semantics of this new syntax is as follows:

virtual_view_flag_I0 equal to 1 indicates that the reference picture in LIST 0 being remapped is a virtual reference view that needs to be generated. virtual_view_flag equal to 0 indicates that the reference picture being remapped is not a virtual reference view.

translation_offset_x_I0 indicates the first component of the translation vector between the view signaled by abs_diff_view_idx_minus 1 in list LIST 0 and the virtual view to be generated.

translation_offset_y_I0 indicates the second component of the translation vector between the view signaled by abs_diff_view_idx_minus 1 in list LIST 0 and the virtual view to be generated.

translation_offset_z_I0 indicates the third component of the translation vector between the view signaled by abs_diff view_idx_minus 1 in list LIST 0 and the virtual view to be generated.

pan_I0 indicates the panning parameter (along y) between the view signaled by abs_diff_view_idx_minus1 in list LIST 0 and the virtual view to be generated.

tilt_I0 indicates the tilting parameter (along x) between the view signaled by abs_diff_view_idx_minus 1 in list LIST 0 and the virtual view to be generated.

rotation_I0 indicates the rotation parameter (along z) between the view signaled by abs_diff_view_idx_minus 1 in list LIST 0 and the virtual view to be generated.

zoom_I0 indicates the zoom parameter between the view signaled by abs_diff_view_idx_minus 1 in list LIST 0 and the virtual view to be generated.

hole_filling_mode_I0 indicates how the holes in the warped picture in LIST 0 would be filled. Different hole filling modes can be signaled. For example, a value of 0 means copy the farthest pixel (i.e. with the largest depth) in the neighborhood, a value of 1 means extend the neighboring background, and a value of 2 means no hole filling.

depth_filter_type_I0 indicates what kind of filter is used for the depth signal in LIST 0. Different filters can be signaled. In one embodiment, a value of 0 means no filter, a value of 1 means a median filter(s), a value of 2 means a bilateral filter(s), and a value of 3 means a Gaussian filter(s).

video_filter_type_I0 indicates what kind of filter is used for the virtual video signal in list LIST 0. Different filters can be signaled. In one embodiment, a value of 0 means no filter, and a value of 1 means a de-noising filter.

virtual_view_flag_I1 uses the same semantics as virtual_view_flag_I0 with I0 being replaced with I1.

translation_offset_x_I1 uses the same semantics as translation_offset_x_I0 with I0 being replaced with I1.

translation_offset_y_I1 uses the same semantics as translation_offset_y_I0 with I0 being replaced with I1.

translation_offset_z_I1 uses the same semantics as translation_offset_z_I0 with I0 being replaced with I1.

pan_I1 uses the same semantics as pan_I0 with I0 being replaced with I1.

tilt_I1 uses the same semantics as tilt_I0 with I0 being replaced with I1.

rotation_I1 uses the same semantics as rotation_I0 with I0 being replaced with I1.

zoom_I1 uses the same semantics as zoom_I0 with I0 being replaced with I1.

hole_filling_mode_I1 uses the same semantics as hole_filling_mode_I0 with I0 being replaced with I1.

depth_filter_type_I1 uses the same semantics as depth_filter_type_I0 with I0 being replaced with I1.

video_filter_type_I1 uses the same semantics as videofilter_type_I0 with I0 being replaced with I1.

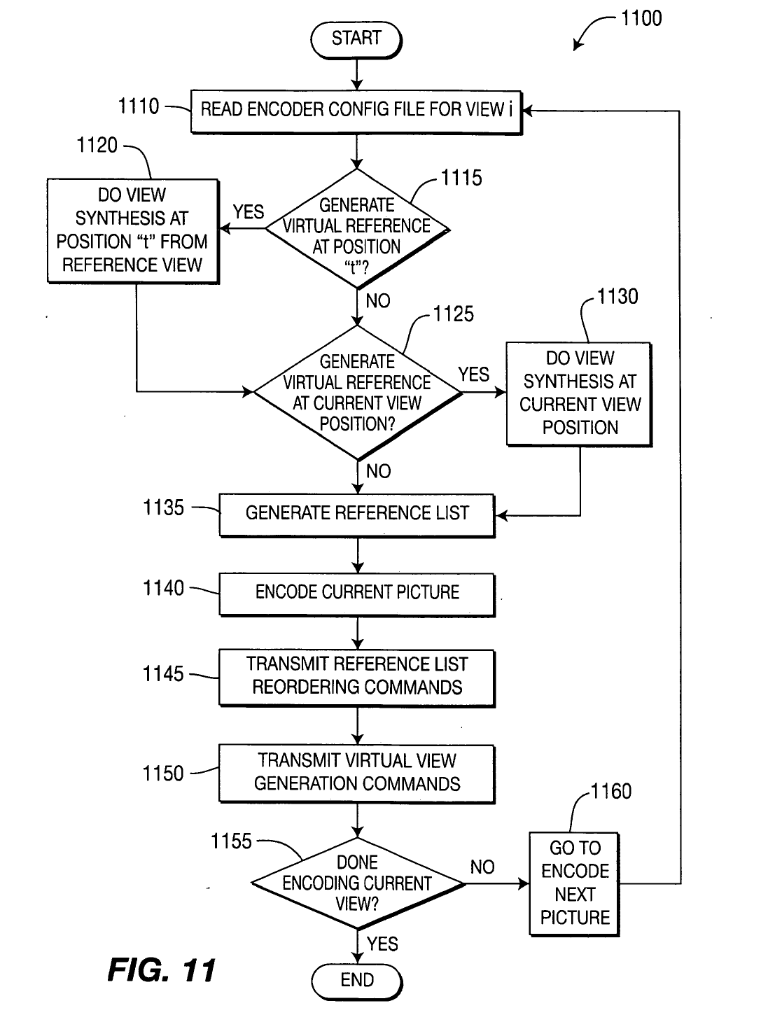

FIG. 11 shows a flowchart for a method 1100 for encoding a virtual reference view, in accordance with another embodiment of the present principles. At step 910, an encoder configuration file is read for view i. At step 1115, it is determined whether or not a virtual reference at position “t” is to be generated. If so, then control is passed to step 1120. Otherwise, control is passed to step 1125. At step 1120, view synthesis is performed at position “t” from the reference view. At step 1125, it is determined whether or not a virtual reference is to be generated at the current view position. If so, then control is passed to step 1130. Otherwise, control is passed to step 1135. At step 1130, view synthesis is performed at the current view position. At step 1135, a reference list is generated. At step 1140, the current picture is encoded. At step 1145, the reference list reordering commands are transmitted. At step 1150, the virtual view generation commands are transmitted. At step 1155, it is determined whether or not encoding of the current view is done. If so, then the method is terminated. Otherwise, control is passed to step 1160. At step 1160, the method proceeds to the next picture to encode and returns to step 1105.

Thus, in FIG. 11, after reading the encoder configuration (per step 1110), it is determined whether a virtual view should be generated at a position “t” (per step 1115). If such a view needs to be generated then view synthesis is performed (per step 1120) along with hole filling (not explicitly shown in FIG. 11) and this virtual view is added as a reference (per step 1135). Subsequently, another virtual view can be generated (per step 1125) at the position of the current camera and also added to the reference list. The encoding of the current view then proceeds with these views as additional references.

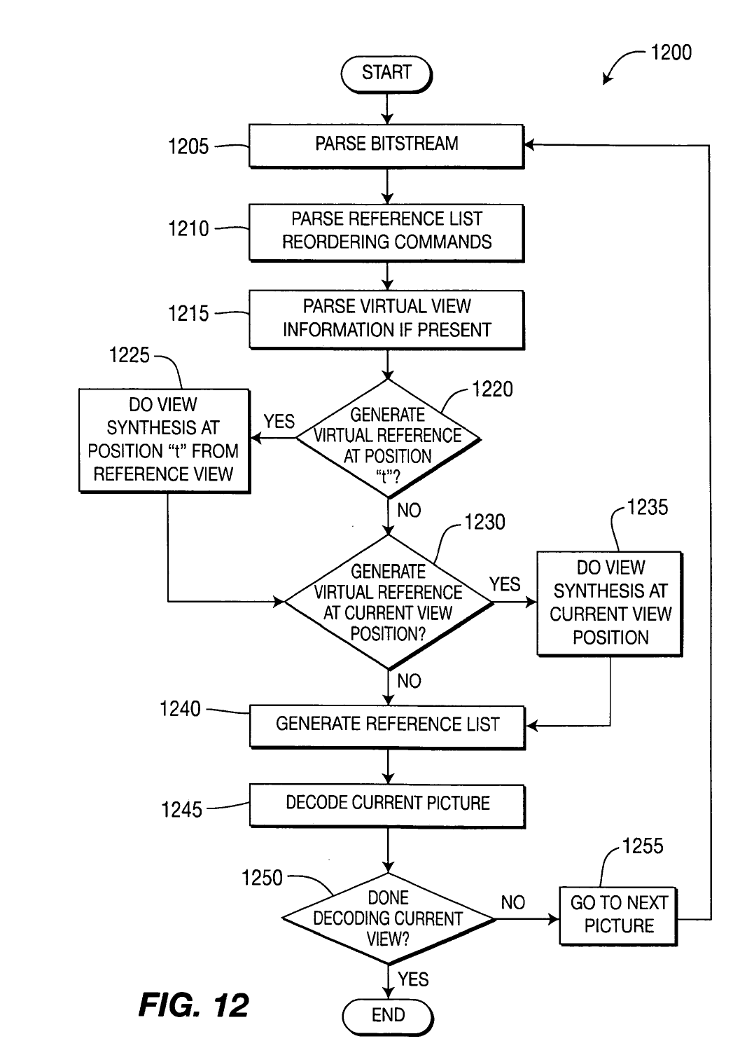

FIG. 12 shows a flowchart for a method 1200 for decoding a virtual reference view, in accordance with another embodiment of the present principles. At step 1205, a bitstream is parsed. At step 1210, reference list reordering commands are parsed. At step 1215, virtual view information is parsed, if present. At step 1220, it is determined whether or not a virtual reference at position “t” is to be generated. If so, then control is passed to step 1225. Otherwise, control is passed to a step 1230. At step 1225, view synthesis is performed at position “t” from the reference view. At step 1230, it is determined whether or not a virtual reference is to be generated at the current view position. If so, then control is passed to step 1235. Otherwise, control is passed to a step 1240. At step 1235, view synthesis is performed at the current view position. At step 1240, a reference list is generated. At step 1245, the current picture is decoded. At step 1250, it is determined whether or not decoding of the current view is done. If so, then the method is terminated. Otherwise, control is passed to step 1055. At step 1255, the method proceeds to the next picture to decode and returns to step 1205.

Thus, in FIG. 12, by parsing the reference list reordering syntax elements (per step 1210), it can be determined if virtual view at a position “t” needs to be generated as an additional reference (per step 1220). If this is the case, view synthesis (per step 1225) and hole filling (not explicitly shown in FIG. 12) are performed to generate this view. In addition, if indicated in the bitstream, another virtual view is generated at the current view position (per step 1230). Both these views are then placed in the reference list (per step 1240) as additional references and decoding proceeds.

### Embodiment 2

In another embodiment, instead of transmitting the intrinsic and extrinsic parameters using the above syntax, one could transmit them as shown in Table 3. Table 3 shows proposed virtual view information syntax, in accordance with another embodiment.

TABLE 3

| virtual_view_info ( ) { | C | Descriptor |
|---|---|---|
| intrinsic_param_flag_l0 | 5 | u(1) |
| if (instrinsic_param_flag_l0) { | | |
| intrinsic_params_equal_l0 | 5 | u(1) |
| prec_focal_length_l0 | 5 | ue(v) |
| prec_principal_point_l0 | 5 | ue(v) |
| prec_radial_distortion_l0 | 5 | ue(v) |
| for( i = 0; i <= num_ref_idx_l0_active_minus1; | | |
| i++ ) { | | |
| sign_focal_length_l0_x[i] | 5 | u(1) |
| exponent_focal_length_l0_x[i] | 5 | u(6) |
| mantissa_focal_length_l0_x[i] | 5 | u(v) |
| sign_focal_length_l0_y[i] | 5 | u(1) |
| exponent_focal_length_l0_y[i] | 5 | u(6) |
| mantissa_focal_length_l0_y[i] | 5 | u(v) |
| sign_principal_point_l0_x[i] | 5 | u(1) |
| exponent_principal_point_l0_x[i] | 5 | u(6) |
| mantissa_principal_point_l0_x[i] | 5 | u(v) |
| sign_principal_point_l0_y[i] | 5 | u(1) |
| exponent_principal_point_l0_y[i] | 5 | u(6) |
| mantissa_principal_point_l0_y[i] | 5 | u(v) |
| sign_radial_distortion_l0 [i] | 5 | u(1) |
| exponent_radial_distortion_l0 [i] | 5 | u(6) |
| mantissa_radial_distortion_l0 [i] | 5 | u(v) |
| } | | |
| } | | |
| extrinsic_param_flag_l0 | 5 | u(1) |
| if(extrinsic_param_flag_l0) { | | |
| prec_rotation_param_l0 | 5 | ue(v) |
| prec_translation_param_l0 | 5 | ue(v) |
| for(i=0; i<= num_ref_idx_l0_active_minus1; | | |
| i++) { | | |
| for (j=1; j<=3; j++) { /* row */ | | |
| for (k=1; k<=3; k++) { /* column */ | | |
| sign_l0_r[i][j][k] | 5 | u (1) |
| exponent_l0_r[i][j][k] | 5 | u(6) |
| mantissa_l0_r[i][j][k] | 5 | u(v) |
| } | | |
| sign_l0_t[i][j] | 5 | u(1) |
| exponent_l0_t[i][j] | 5 | u(6) |
| mantissa_l0_t[i][j] | 5 | u(v) |
| } | | |
| } | | |
| } | | |
| if( slice_type % 5 = = 1 ) { | | |
| intrinsic_param_flag_l1 | 5 | u(1) |
| if (instrinsic_param_flag_l1) { | | |
| intrinsic_params_equal_l1 | 5 | u(1) |
| prec_focal_length_l1 | 5 | ue(v) |
| prec_principal_point_l1 | 5 | ue(v) |
| prec_radial_distortion_l1 | 5 | ue(v) |
| for( i = 0; i <= | | |
| num_ref_idx_l1_active_minus1; | | |
| i++ ) { | | |
| sign_focal_length_l1_x[i] | 5 | u(1) |
| exponent_focal_length_l1_x[i] | 5 | u(6) |
| mantissa_focal_length_l1_x[i] | 5 | u(v) |
| sign_focal_length_l1_y[i] | 5 | u(1) |
| exponent_focal_length_l1_y[i] | 5 | u(6) |
| mantissa_focal_length_l1_y[i] | 5 | u(v) |
| sign_principal_point_l1_x[i] | 5 | u(1) |
| exponent_principal_point_l1_x[i] | 5 | u(6) |
| mantissa_principal_point_l1_x[i] | 5 | u(v) |
| sign_principal_point_l1_y[i] | 5 | u(1) |
| exponent_principal_point_l1_y[i] | 5 | u(6) |
| mantissa_principal_point_l1_y[i] | 5 | u(v) |
| sign_radial_distortion_l1 [i] | 5 | u(1) |
| exponent_radial_distortion_l1 [i] | 5 | u(6) |
| mantissa_radial_distortion_l1 [i] | 5 | u(v) |
| } | | |
| } | | |
| extrinsic_param_flag_l1 | 5 | u(1) |
| if(extrinsic_param_flag_l1) { | | |
| prec_rotation_param_l1 | 5 | ue(v) |
| prec_translation_param_l1 | 5 | ue(v) |
| for(i=0; i<= num_ref_idx_l1_active_minus1; | | |
| i++) { | | |
| for (j=1; j<=3; j++) { /* row */ | | |
| for (k=1; k<=3; k++) { /* column */ | | |
| sign_l1_r[i][j][k] | 5 | u (1) |
| exponent_l1_r[i][j][k] | 5 | u(6) |
| mantissa_l1_r[i][j][k] | 5 | u(v) |
| } | | |
| sign_l1_t[i][j] | 5 | u(1) |
| exponent_l1_t[i][j] | 5 | u(6) |
| mantissa_l1_t[i][j] | 5 | u(v) |
| } | | |
| } | | |
| } | | |
| } | | |
| } | | |

The syntax elements would then have the following semantics.

intrinsic_param_flag_I0 equal to 1 indicates the presence of intrinsic camera parameters for LIST_{—}0. intrinsic_param_flag_I0 equal to 0 indicates the absence of intrinsic camera parameters for LIST_{—}0.

intrinsic_params_equal_I0 equal to 1 indicates that the intrinsic camera parameters for LIST_{—}0 are equal for all cameras and only one set of intrinsic camera parameters are present. intrinsic_params_equal_I0 equal to 0 indicates that the intrinsic camera parameters for LIST_{—}1 are different for each camera and that a set of intrinsic camera parameters are present for each camera.

prec_focal_length_I0 specifies the exponent of the maximum allowable truncation error for focal_length_I0_x[i] and focal_length_I0_y[i] as given by 2^{-prec}^{_{—}}^{focal}^{_{—}}^{length}^{_{—}}^{I0}.

prec_principal point_I0 specifies the exponent of the maximum allowable truncation error for principal_point_I0_x[i] and principal_point_I0_y[i] as given by 2^{-prec}^{_{—}}^{principal point}^{_{—}}^{I0}.

prec_radial_distortion_I0 specifies the exponent of the maximum allowable truncation error for radial_distortion_I0 as given by 2^{-prec}^{_{—}}^{radial}^{_{—}}^{distortion}^{_{—}}^{I0}.

sign_focal_length_I0_x[i] equal to 0 indicates that the sign of the focal length of the i-th camera in LIST 0 in the horizontal direction is positive. sign_focal_length_I0_x[i] equal to 0 indicates that the sign is negative.

exponent_focal_length_I0_x[i] specifies the exponent part of the focal length of the i-th camera in LIST 0 in the horizontal direction.

mantissa_focal_length_I0_x[i] specifies the mantissa part of the focal length of the i-th camera in LIST 0 in the horizontal direction. The size of the mantissa_focal_length_I0_x[i] syntax element is determined as specified below.

sign_focal_length_I0_y[i] equal to 0 indicates that the sign of the focal length of the i-th camera in LIST 0 in the vertical direction is positive. sign_focal_length_I0_y[i] equal to 0 indicates that the sign is negative.

exponent_focal_length_I0_y[i] specifies the exponent part of the focal length of the i-th camera in LIST 0 in the vertical direction.

mantissa_focal_length_I0_y[i] specifies the mantissa part of the focal length of the i-th camera in LIST 0 in the vertical direction. The size of the mantissa_focal_length_I0_y[i] syntax element is determined as specified below.

sign_principal_point_I0_x[i] equal to 0 indicates that the sign of the principal point of the i-th camera in LIST 0 in the horizontal direction is positive. sign_principal_point_I0_x[i] equal to 0 indicates that the sign is negative.

exponent_principal_point_I0_x[i] specifies the exponent part of the principal point of the i-th camera in LIST 0 in the horizontal direction.

mantissa_principal_point_I0_x[i] specifies the mantissa part of the principal point of the i-th camera in LIST 0 in the horizontal direction. The size of the mantissa_principal_point_I0_x[i] syntax element is determined as specified below.

sign_principal_point_I0_y[i] equal to 0 indicates that the sign of the principal point of the i-th camera in LIST 0 in the vertical direction is positive. sign_principal_point_I0_y[i] equal to 0 indicates that the sign is negative.

exponent_principal_point_I0_y[i] specifies the exponent part of the principal point of the i-th camera in LIST 0 in the vertical direction.

mantissa_principal_point_I0_y[i] specifies the mantissa part of the principal point of the i-th camera in LIST 0 in the vertical direction. The size of the mantissa_principal_point_I0_y[i] syntax element is determined as specified below.

sign_radial_distortion_I0[i] equal to 0 indicates that the sign of the radial distortion coefficient of the i-th camera in LIST 0 is positive. sign_radial_distortion_I0[i] equal to 0 indicates that the sign is negative.

exponent_radial_distortion_I0[i] specifies the exponent part of the radial distortion coefficient of the i-th camera in LIST 0.

mantissa_radial_distortion_I0 [i] specifies the mantissa part of the radial distortion coefficient of the i-th camera in LIST 0. The size of the mantissa_radial_distorion_I0 [i] syntax element is determined as specified below.

Table 4 shows the intrinsic matrix A(i) for i-th camera.

TABLE 4

| focal_length_l0_x[i] | radial_distortion_l0[i] | principal_point_l0_x[i] |
|---|---|---|
| 0 | focal_length_l0_y[i] | principal_point_l0_y[i] |
| 0 | 0 | 1 |

extrinsic_param_flag_I0 equal to 1 indicates the presence of extrinsic camera parameters in LIST 0. extrinsic_param_flag_I0 equal to 0 indicates the absence of extrinsic camera parameters.

prec_rotation_param_I0 specifies the exponent of the maximum allowable truncation error for r[i][j][k] as given by 2^{-prec}^{_{—}}^{rotation}^{_{—}}^{param}^{_{—}}^{I0} for LIST 0.

prec_translation_param_I0 specifies the exponent of the maximum allowable truncation error for t[i][j] as given by 2^{-prec}^{_{—}}^{translation}^{_{—}}^{param}^{_{—}}^{I0} for LIST 0.

sign_I0_r[i][j][k] equal to 0 indicates that the sign of the (j,k) component of the rotation matrix for the i-th camera in LIST 0 is positive. sign_I0_r[i][j][k] equal to 0 indicates that the sign is negative.

exponent_I0_r[i][j][k] specifies the exponent part of the (j,k) component of the rotation matrix for the i-th camera in LIST 0.

mantissa_I0 r[i][j][k] specifies the mantissa part of the (j,k) component of the rotation matrix for the i-th camera in LIST 0. The size of the mantissa_I0_r[i][j][k] syntax element is determined as specified below.

Table 5 shows the rotation matrix R(i) for i-th camera.

TABLE 5

| | | |
|---|---|---|
| r[i][0][0] | r[i][0][1] | r[i][0][2] |
| r[i][1][0] | r[i][1][1] | r[i][1][2] |
| r[i][2][0] | r[i][2][1] | r[i][2][2] |

sign_I0_t[i][j] equal to 0 indicates that the sign of the j-th component of the translation vector for the i-the camera in LIST 0 is positive. sign_I0_t[i][j] equal to 0 indicates that the sign is negative.

exponent_I0_t[i][j] specifies the exponent part of the j-th component of the translation vector for the i-the camera in LIST 0.

mantissa_I0_t[i][j] specifies the mantissa part of the j-th component of the translation vector for the i-the camera in LIST 0. The size of the mantissa_I0_t[i][j] syntax element is determined as specified below.

Table 6 shows the translation vector t(i) for i-th camera.

TABLE 6
t[i][0]
t[i][1]
t[i][2]

The components of the intrinsic and rotation matrices as well as the translation vector are obtained as follows in a manner akin to the IEEE 754 standard:

If E=63 and M is non-zero, then X is not a number.

If E=63 and M=0, then X=(−1)^{S}·∞.

If 0<E<63, then X=(−1)^{S} ·2^{E-31}·(1·M).

If E=0 and M is non-zero, then X=(−1)^{S}·2⁻³⁰·(0·M).

If E=0 and M=0, then X=(−1)^{s} ·0,

where M=bin2float(N) with 0<=M<1 and each of X , s, N and E correspond to the first, second, third and fourth column of Table 7. See below for a c-style description of the function bin2float( )which converts a binary representation of a fractional number into the corresponding floating-point number.

TABLE 7

| X | s | E | N |
|---|---|---|---|
| focal_length_l0_x[i] | sign_focal_length_l0_x[i] | exponent_focal_length_l0_x[i] | mantissa_focal_length_l0_x[i] |
| focal_length_l0_y[i] | sign_focal_length_l0_y[i] | exponent_focal_length_l0_y[i] | mantissa_focal_length_l0_y[i] |
| principal_point_l0_x[i] | sign_principal_point_l0_x[i] | exponent_principal_point_l0_x[i] | mantissa_principal_point_l0_x[i] |
| principal_point_l0_y[i] | sign_principal_point_l0_y[i] | exponent_principal_point_l0_y[i] | mantissa_principal_point_l0_y[i] |
| radial_distortion l0_[i] | sign_radial_distortion l0_[i] | exponent_radial_distortion l0_[i] | mantissa_radial_distortion l0_[i] |
| r l0_[i][j][k] | sign_l0_r[i][j][k] | exponent_l0_r[i][j][k] | mantissa_l0_r[i][j][k] |
| t l0_[i][j] | sign_l0_t[i][j] | exponent_l0_t[i][j] | mantissa_l0_t[i][j] |

An example c-implementation of M=bin2float(N) which converts a binary representation of a fractional number N (0<=N<1) into the corresponding floating-point number M is shown in Table 8.

```
TABLE 8
float M=0;
float factor =2\hat{ }(-v); /* v is the length of the mantissa */
for (i=0; i<v; i++) {
  M = M + factor*(N>>i)&0x01;
  factor = factor*2; }
```

The size v of a mantissa syntax element is determined as follows:
v=max(0, −30+Precision_Syntax_Element), if E=0.
v=max(0, E −30+Precision_Syntax_Element), if 0<E<63.
v=0, if E=31,
   where the mantissa syntax elements and their corresponding E and Precision_Syntax_Element are given in Table 9.

TABLE 9

| Mantissa Syntax Element | E | Precision_Syntax_Element |
|---|---|---|
| mantissa_focal_length_l0_x[i] | exponent_focal_length_l0_x[i] | prec_focal_length_l0_x[i] |
| mantissa_focal_length_l0_y[i] | exponent_focal_length_l0_y[i] | prec_focal_length_l0_yi] |
| mantissa_principal_point_l0_x[i] | exponent_principal_point_l0_x[i] | prec_principal_point_l0_x[i] |
| mantissa_principal_point_l0_y[i] | exponent_principal_point_l0_y[i] | prec_principal_point_l0_y[i] |
| mantissa_radial_distortion_l0[i] | exponent_radial_distortion_l0[i] | prec_radial_distortion_l0[i] |
| mantissa_l0_r[i][j][k] | exponent_l0_r[i][j][k] | prec_l0_r[i][j][k] |
| mantissa_l0_t[i][j] | exponent_l0_t[i][j] | prec_l0_t[i][j] |

For the syntax elements with “I1”, replace LIST 0 by LIST 1 in the semantics for syntax with “I0”.

### Embodiment 3

In another embodiment, the virtual view can be refined successively as follows.

First, we generate a virtual view between view 1 and view 5 at a distance of t1 from view 1. After the 3D warping, the holes are filled to generate the final virtual view at position P(t1). We can then warp the depth signal of view 1 at the virtual camera position V(t1) and fill the holes for the depth signal and perform any other needed post processing steps. Implementations may also use warped depth data to generate a warped view.

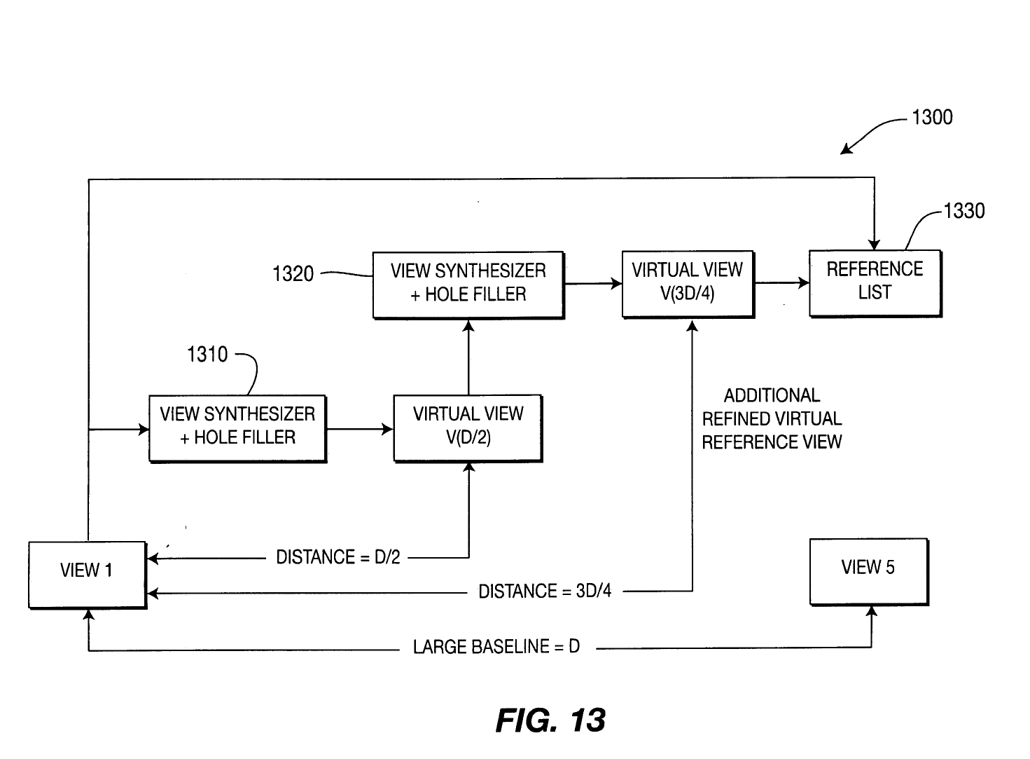

After this we can generate another virtual view between virtual view at V(t1) and view 5 at a distance t2 from V(t1) in the same way as V(t1). This is shown in FIG. 13. FIG. 13 shows an example of successive virtual view generator 1300, to which the present principles may be applied, in accordance with an embodiment of the present principles. The virtual view generator 1300 includes a first view synthesizer and hole filler 1310 and a second view synthesizer and hole filler 1320. In the example, view 5 represents a view to be coded, and view 1 represents a reference view that is available (for example, for use in coding view 5 or some other view). In the example, we have selected to use the mid point between 2 cameras as the intermediate locations. Thus, in the 1st step, t1 is selected as D/2 and a virtual view is generated as V(D/2) after hole filling by the first view synthesizer and hole filler 1310. Subsequently, another intermediate view is generated at position 3D/4 using V(D/2) and V5 by the second view synthesizer and hole filler 1320. This virtual view V(3D/4) can then be added to the reference list 1330.

Similarly, we can generate more virtual views as needed until a quality metric is satisfied. An example of a quality measure could be the prediction error between the virtual view and the view to be predicted, for example, view 5. The final virtual view can then be used as a reference for view 5. All the intermediate views can also be added as references by using appropriate reference list ordering syntax.

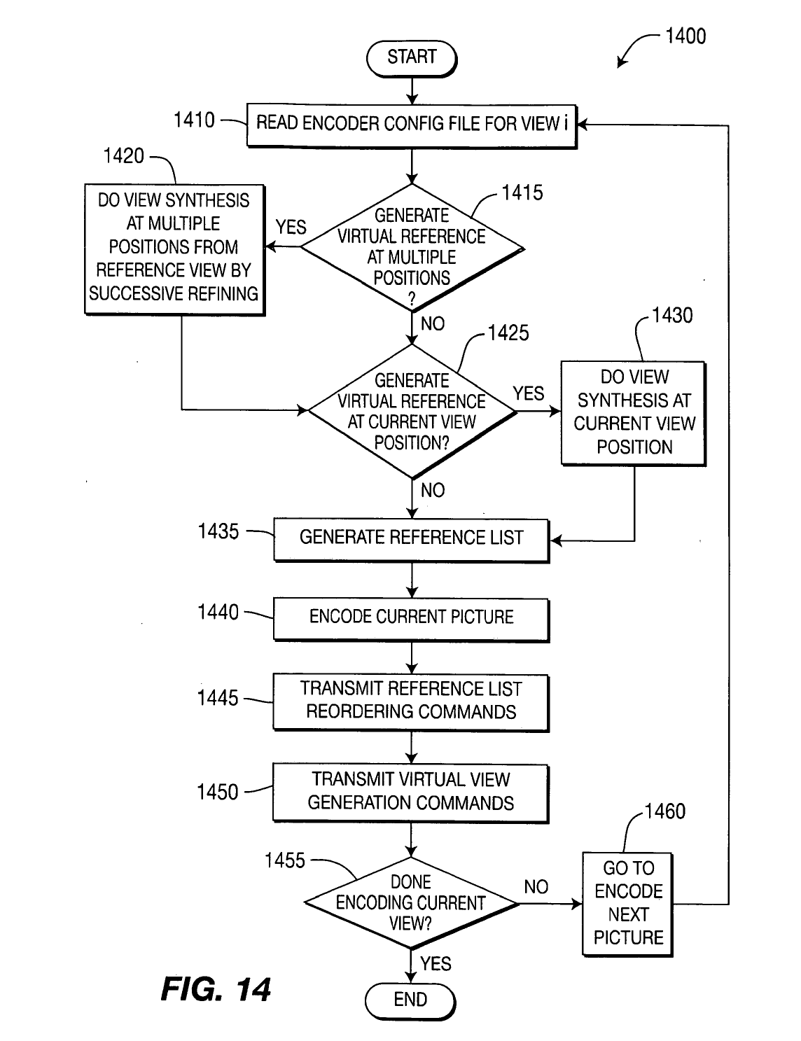

FIG. 14 shows a flowchart for a method 1400 for encoding a virtual reference view, in accordance with yet another embodiment of the present principles. At step 1410, an encoder configuration file is read for view i. At step 1415, it is determined whether or not a virtual reference at multiple positions is to be generated. If so, then control is passed to step 1420. Otherwise, control is passed to step 1425. At step 1420, view synthesis is performed at multiple positions from the reference view by successive refining. At step 1425, it is determined whether or not a virtual reference is to be generated at the current view position. If so, then control is passed to step 1430. Otherwise, control is passed to step 1435. At step 1430, view synthesis is performed at the current view position. At step 1435, a reference list is generated. At step 1440, the current picture is encoded. At step 1445, the reference list reordering commands are transmitted. At step 1450, the virtual view generation commands are transmitted. At step 1455, it is determined whether or not encoding of the current view is done. If so, then the method is terminated. Otherwise, control is passed to step 1460. At step 1460, the method proceeds to the next picture to encode and returns to step 1405.

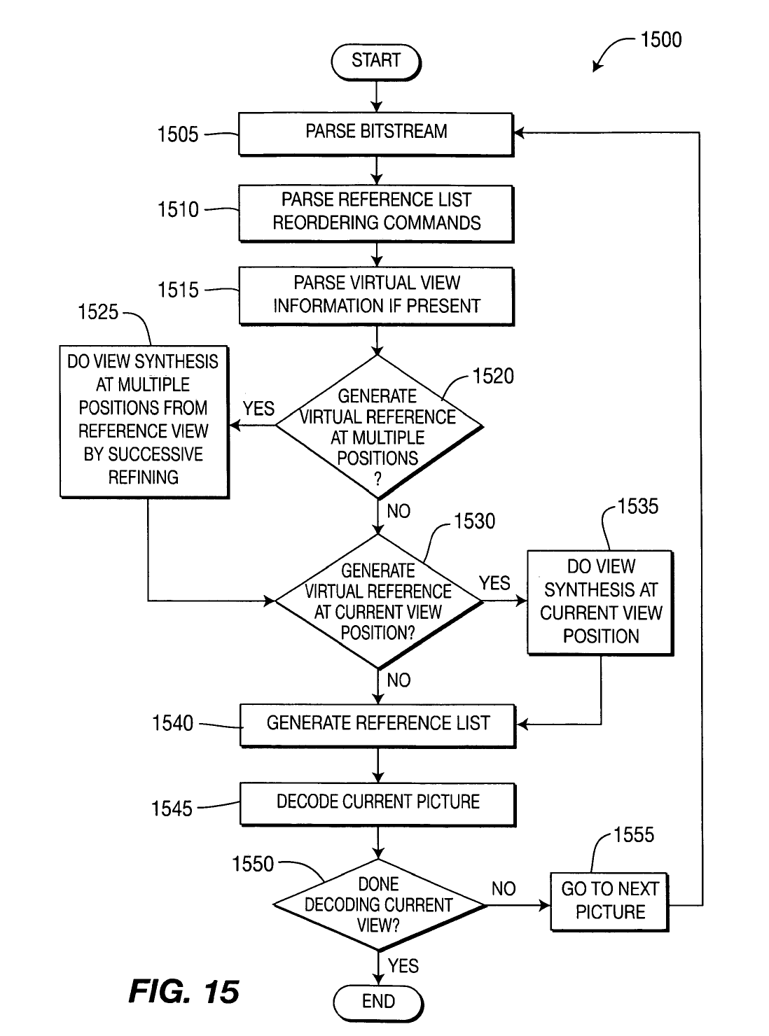

FIG. 15 shows a flowchart for a method 1500 for decoding a virtual reference view, in accordance with yet another embodiment of the present principles. At step 1505, a bitstream is parsed. At step 1510, reference list reordering commands are parsed. At step 1515, virtual view information is parsed, if present. At step 1520, it is determined whether or not a virtual reference at multiple positions is to be generated. If so, then control is passed to step 1525. Otherwise, control is passed to a step 1530. At step 1525, view synthesis is performed at multiple positions from the reference view by successive refining. At step 1530, it is determined whether or not a virtual reference is to be generated at the current view position. If so, then control is passed to step 1535. Otherwise, control is passed to a step 1540. At step 1535, view synthesis is performed at the current view position. At step 1540, a reference list is generated. At step 1545, the current picture is decoded. At step 1550, it is determined whether or not decoding of the current view is done. If so, then the method is terminated. Otherwise, control is passed to step 1555. At step 1555, the method proceeds to the next picture to decode and returns to step 1505.

As can be seen, a difference between this embodiment and Embodiment 1 is that at the encoder instead of just a single virtual view at “t”, several virtual views can be generated at positions t1, t2, t3 by successive refinement. All these virtual views, or the best virtual view, for example, can then be placed in the final reference list. At the decoder, reference list reordering syntax will indicate at how many positions the virtual views need to be generated. These are then placed in the reference list prior to decoding.

There is thus provided a variety of implementations. Included in these implementations are implementations that, for example, include one or more of the following advantages/features:

1. generate a virtual view from at least one other view, and use the virtual view as a reference view in encoding,

2. generate a second virtual view from at least a first virtual view,

2a. use the second virtual view (of item 2 immediately herein before) as a reference view in encoding,

2b. generate the second virtual view (of 2) in a 3D application,

2e. generate a third virtual view from at least the second virtual view (of 2),

2f. generate the second virtual view (of 2) at a camera location (or an existing “view” location),

3. generate multiple virtual views between two existing views, and generate successive ones of the multiple virtual views based on the preceding one of the multiple virtual views,

3a. generate the successive virtual views (of 3) such that a quality metric improves for each of the successive views that are generated, or

3b. use a quality metric (in 3) that is a measure of the prediction error (or residue) between the virtual view and one of the two existing views that is being predicted.

Several of these implementations include a feature that a virtual view is generated at an encoder, rather than (or in addition to) generating a virtual view in an application (such as a 3D application) after decoding has occurred. Additionally, the implementations and features described herein may be used in the context of the MPEG-4 AVC Standard, or the MPEG-4 AVC Standard with the multi-view video coding (MVC) extension, or the MPEG-4 AVC Standard with the scalable video coding (SVC) extension. However, these implementations and features may be used in the context of another standard and/or recommendation (existing or future), or in a context that does not involve a standard and/or recommendation. We thus provide one or more implementations having particular features and aspects. However, features and aspects of described implementations may also be adapted for other implementations.

Implementations may signal information using a variety of techniques including, but not limited to, slice headers, SEI messages, other high level syntax, non-high-level syntax, out-of-band information, data stream data, and implicit signaling. Accordingly, although implementations described herein may be described in a particular context, such descriptions should in no way be taken as limiting the features and concepts to such implementations or contexts.

We thus provide one or more implementations having particular features and aspects. However, features and aspects of described implementations may also be adapted for other implementations. Implementations may signal information using a variety of techniques including, but not limited to, SEI messages, other high level syntax, non-high-level syntax, out-of-band information, datastream data, and implicit signaling. Accordingly, although implementations described herein may be described in a particular context, such descriptions should in no way be taken as limiting the features and concepts to such implementations or contexts.

Additionally, many implementations may be implemented in either, or both, an encoder and a decoder.

Reference in the specification, including the claims, to “accessing” is intended to be general. “Accessing” a piece of data, for example, may be performed, for example, in the process of receiving, sending, storing, transmitting, or processing the piece of data. Thus, for example, an image is typically accessed when the image is stored to memory, retrieved from memory, encoded, decoded, or used as a basis for synthesizing a new image.

Reference in the specification to a reference image being “based on” another image (for example, a synthesized image) allows for the reference image to be equal to the other image (no further processing occurred) or to be created by processing the other image. For example, a reference image may be set equal to a first synthesized image, and still be “based on” the first synthesized image. Also, the reference image may be “based on” the first synthesized image by being a further synthesis of the first synthesized image, moving the virtual location to a new location (as described, for example, in the incremental synthesis implementations).

Reference in the specification to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

1. A method comprising:
accessing coded video information for a first-view image that corresponds to a first-view location;
accessing a reference image depicting the first-view image from a virtual-view location different from the first-view location, wherein the reference image is based on a synthesized image for a location that is between the first-view location and a second-view location;
accessing coded video information for a second-view image that corresponds to a second-view location, the second-view image having been coded based on the reference image; and
decoding the second-view image using the coded video information for the second-view image and the reference image to produce a decoded second-view image.

2. The method of claim 1, further comprising synthesizing the reference image.

3. The method of claim 1, further comprising encoding and transmitting the reference image.

4. The method of claim 1, further comprising receiving the reference image.

5. The method of claim 1, wherein the reference image is a reconstruction of an original reference image.

6. The method of claim 1, further comprising receiving control information indicating which view of a plurality of views corresponds to the virtual-view location of the reference image.

7. The method of claim 6, further comprising receiving the first-view image and the second-view image.

8. The method of claim 1, further comprising transmitting the first-view image and the second-view image.

9. The method of claim 1, wherein the first-view image comprises a reconstructed version of an original first-view image.

10. The method of claim 1, wherein the reference image is a virtual image synthesized from the first-view image.

11. The method of claim 1, wherein the reference image is the synthesized image.

12. The method of claim 1, wherein the reference image is another separate synthesized image that is synthesized from the synthesized image, and the reference image is at a location between the first-view image and the second-view image or at a location of the second-view image.

13. The method of claim 1, wherein the reference image has been incrementally synthesized starting by generating a synthesis of the first-view image at a location between the first-view location and the second-view location, and then using a result thereof to synthesize another image closer to the second-view location.

14. The method of claim 1, further comprising using the decoded second-view image to encode a subsequent image at an encoder.

15. The method of claim 1, further comprising using the decoded second-view image to decode a subsequent image at a decoder.

16. An apparatus comprising:
means for accessing coded video information for a first-view image that corresponds to a first-view location;
means for accessing a reference image depicting the first-view image from a virtual-view location different from the first-view location, wherein the reference image is based on a synthesized image for a location that is between the first-view location and the second-view location;
means for accessing coded video information for a second-view image that corresponds to a second-view location, the second-view image having been coded based on the reference image; and
means for decoding the second-view image using the coded video information for the second-view image and the reference image to produce a decoded second-view image.

17. The apparatus of claim 16, wherein the apparatus is implemented in at least one of a video encoder and a video decoder.

18. A processor readable medium having stored thereon instructions for causing a processor to perform at least the following:
accessing coded video information for a first-view image that corresponds to a first-view location;
accessing a reference image depicting the first-view image from a virtual-view location different from the first-view location, wherein the reference image is based on a synthesized image for a location that is between the first-view location and the second-view location;
accessing coded video information for a second-view image that corresponds to a second-view location, the second-view image having been coded based on the reference image; and
decoding the second-view image using the coded video information for the second-view image and the reference image to produce a decoded second-view image.

19. An apparatus, comprising a processor configured to perform at least the following:
accessing coded video information for a first-view image that corresponds to a first-view location;
accessing a reference image depicting the first-view image from a virtual-view location different from the first-view location, wherein the reference image is based on a synthesized image for a location that is between the first-view location and the second-view location;
accessing coded video information for a second-view image that corresponds to a second-view location, the second-view image having been coded based on the reference image; and
decoding the second-view image using the coded video information for the second-view image and the reference image to produce a decoded second-view image.

20. An apparatus comprising:
an accessing unit for (1) accessing coded video information for a first-view image that corresponds to a first-view location, and (2) accessing coded video information for a second-view image that corresponds to a second-view location, the second-view image having been coded based on a reference image;
a storage device for accessing the reference image, the reference image depicting the first-view image from a virtual-view location different from the first-view location, wherein the reference image is based on a synthesized image for a location that is between the first-view location and the second-view location; and
a decoding unit for decoding the second-view image using the coded video information for the second-view image and the reference image to produce a decoded second-view image.

21. The apparatus of claim 20, wherein the accessing unit comprises an encoding unit a bitstream parser.

22-24. (canceled)

25. A video signal structure comprising:
a first-view portion for coded video information for a first-view image that corresponds to a first-view location;
a second-view portion for coded video information for a second-view image that corresponds to a second-view location, the second-view image having been coded based on a reference image; and
a reference portion for coded information indicating the reference image, the reference image depicting the first-view image from a virtual-view location different from the first-view location, wherein the reference image is based on a synthesized image for a location that is between the first-view location and the second-view location.

26. The video signal structure of claim 25 wherein the reference portion is for coded information that indicates a view-location of the reference image.

27. A processor readable medium having stored thereon a video signal structure, comprising:
a first-view portion including coded video information for a first-view image that corresponds to a first-view location;
a second-view portion including coded video information for a second-view image that corresponds to a second-view location, the second-view image having been coded based on a reference image; and
a reference portion including coded information indicating the reference image, the reference image depicting the first-view image from a virtual-view location different from the first-view location, wherein the reference image is based on a synthesized image for a location that is between the first-view location and the second-view location.

28. An apparatus comprising:
an accessing unit for (1) accessing coded video information for a first-view image that corresponds to a first-view location, and (2) accessing coded video information for a second-view image that corresponds to a second-view location, the second-view image having been coded based on a reference image;
a storage device for accessing the reference image, the reference image depicting the first-view image from a virtual-view location different from the first-view location, wherein the reference image is based on a synthesized image for a location that is between the first-view location and the second-view location;
a decoding unit for decoding the second-view image using the coded video information for the second-view image and the reference image to produce a decoded second-view image; and
a modulator for modulating a signal that includes the first-view image and the second-view image.

29. An apparatus comprising:
a demodulator for receiving and demodulating a signal, the signal including coded video information for a first-view image that corresponds to a first-view location, and including coded video information for a second-view image that corresponds to a second-view location, the second-view image having been coded based on a reference image;
an accessing unit for accessing the coded video information for the first-view image and the coded video information for the second-view image;
a storage device for accessing the reference image, the reference image depicting the first-view image from a virtual-view location different from the first-view location, wherein the reference image is based on a synthesized image for a location that is between the first-view location and the second-view location; and
a decoding unit for decoding the second-view image using the coded video information for the second-view image and the reference image to produce a decoded second-view image.

30. The apparatus of claim 29, further comprising a view synthesizer for synthesizing the reference image.

31. A method comprising:
accessing a first-view image corresponding to a first-view location;
synthesizing a virtual image, based on the first-view image, for a virtual-view location different from the first-view location; and
encoding a second-view image corresponding to a second-view location, the encoding using a reference image that is based on the virtual image, and the second-view location being different from the virtual-view location, the encoding producing an encoded second-view image.

32. The method of claim 31, wherein the reference image is the virtual image.

33. An apparatus comprising:
means for accessing a first-view image corresponding to a first-view location;
means for synthesizing a virtual image, based on the first-view image, for a virtual-view location different from the first-view location; and
means for encoding a second-view image corresponding to a second-view location, the encoding using a reference image that is based on the virtual image, and the second-view location being different from the virtual-view location, the encoding producing an encoded second-view image.

34. An apparatus comprising:
an encoding unit for accessing a first-view image corresponding to a first-view location, and for encoding a second-view image corresponding to a second-view location, the encoding using a reference image that is based on a virtual image, and the second-view location being different from the virtual-view location, the encoding producing an encoded second-view image; and
a view synthesizer for synthesizing the virtual image, based on the first-view image, wherein the virtual image is for a virtual-view location different from the first-view location and the second-view location.

35. An apparatus comprising:
an encoding unit for accessing a first-view image corresponding to a first-view location, and for encoding a second-view image corresponding to a second-view location, the encoding using a reference image that is based on a virtual image, and the second-view location being different from the virtual-view location, the encoding producing an encoded second-view image;
a view synthesizer for synthesizing the virtual image, based on the first-view image, wherein the virtual image is for a virtual-view location different from the first-view location and the second-view location; and
a modulator for modulating a signal that includes the encoded second-view image.
